(19) United States
(12) Patent Application Publication
(10) Pub. No.: US 2011/0135411 A1
(43) Pub. Date: Jun. 9, 2011

(54) DRILL TEMPLATE WITH INTEGRAL VACUUM ATTACH HAVING PLUGS

(76) Inventors: John E. Inman, Frontenac, MO (US); David Michael Dietrich, Saint Peters, MO (US); John G. Macke, JR., St. Charles, MO (US); Michael W. Hayes, Belleville, IL (US)

(21) Appl. No.: 12/630,417

(22) Filed: Dec. 3, 2009

(51) Int. Cl. B23B 47/28; B23B 35/00; B23B 47/34

(52) U.S. Cl. 408/1 R; 408/76; 408/56; 408/67

(57) ABSTRACT

A method of reducing foreign object debris (FOD) during drilling operations is provided. The method includes disposing a vacuum housing with a computer aided design (CAD) formed drill template in an operative position on a work piece, actuating a vacuum operatively connected to the vacuum housing, thereby creating negative pressure between the template and the work piece, the negative pressure acting on the debris resulting from the drilling operations, and enhancing the negative pressure without manipulating the vacuum.

### BACKGROUND

The present disclosure generally relates to manufacture and assembly of structures and, more particularly, to drilling holes into a part at precise locations and angles. The disclosure further relates to the collecting of debris, for example, as generated when drilling into a composite or metallic aircraft part. Such debris includes one or more of composite dust, metallic drill chips, water, and any other lubricating or cooling fluids generated by the drilling process.

In conventional practice, before a pattern of holes is drilled in a part to be assembled into a structure, a template, or jig, is made and placed on the surface of the part to be drilled. For example, in the aerospace industry, the structure, or assembly, may be a composite aircraft skin over an aluminum substructure. Examples may also be found in the marine and refrigeration industries, such as applications to boat hulls and heating/air conditioning ducts. The template or jig contains holes conforming to the desired hole pattern that is to be made on the surface of the part to be drilled. A drill is then inserted, typically manually by a drill operator, in each hole of the jig and is used to drill a hole into or through the part.

The drilling process generates particles of material, such as metal and composite debris, from the structure. For example, aircraft skin often includes composite materials—such as carbon and epoxy—which release a dust of fine particles when drilled through. Additionally, water or other fluids may be used during drilling to reduce heat created by the drilling process. For health and safety reasons, operators are required to collect the carbon epoxy dust with a vacuum collection system during the drilling process. Prior art templates generally include a flat plate with a separate vacuum system where the operator or operators must position the template and operate a drill separately from the vacuum system. If the templates do include a vacuum system, there often is a loss in suction due to the open holes that allow for drilling. Additionally, cleanup of the drilling often is labor intensive as well as time intensive as water and particles that may have not been captured by the vacuum could escape through the currently unused drill holes in the template.

As can be seen, there is a need for a template for drilling a pattern of holes in a structure and for collecting debris generated by the drilling process without the time and costs associated with clean up. There is also a need for a drill template with an integral vacuum collection system that allows for a stronger suction via the vacuum.

### BRIEF DESCRIPTION

In one aspect, a method of reducing foreign object debris (FOD) during drilling operations is provided. The method includes disposing a vacuum housing with a computer aided design (CAD) formed drill template in an operative position on a work piece, actuating a vacuum operatively connected to the vacuum housing, thereby creating negative pressure between the template and the work piece, the negative pressure acting on the debris resulting from the drilling operations, and enhancing the negative pressure without manipulating the vacuum.

In another aspect, a drill template for placement adjacent a structure is provided. The drill template includes a vacuum housing comprising a structure contact surface defined to fit adjacent a mold line surface of the structure, a vacuum port extending from the vacuum housing, a plurality of drill bushings extending through the vacuum housing from an outer surface to an inner surface of the vacuum housing, the drill bushings in fluid communication with the vacuum port, and at least one drill bushing plug operable for insertion into one of the drill bushings. The drill bushing plugs are operable for preventing ingress or egress of fluid or debris through the drill bushing into which the drill bushing plug is inserted and further operable for increasing a draw through another of the drill bushings when a vacuum is attached to the vacuum port. The vacuum housing, the vacuum port, the drill bushings, and the at least one drill bushing plug are concurrently fabricated using an additive manufacturing process.

### BRIEF DESCRIPTION OF THE DRAWINGS

FIG. 1 is a top view of a drill template.

FIG. 2 is a bottom view of the drill template of FIG. 1.

FIG. 3 is an oblique view of the drill template of FIG. 1.

FIG. 4 is a view of the drill template of FIG. 1 including a plurality of drill bushing plugs inserted therein.

FIG. 5 is an oblique view of the drill template of FIG. 1 positioned on a surface of a structure.

The features, functions, and advantages that have been discussed can be achieved independently in various embodiments of the present invention or may be combined in yet other embodiments further details of which can be seen with reference to the following description and drawings.

### DETAILED DESCRIPTION OF THE INVENTION

The following detailed description is of the best currently contemplated mode of carrying out the invention. The description is not to be taken in a limiting sense, but is made merely for the purpose of illustrating the general principles of the invention, since the scope of the invention is best defined by the appended claims.

Broadly, one embodiment of the present invention provides a template for precisely drilling a pattern of holes in a structure and for collecting debris generated by the drilling process including plugs for insertion into holes that are not being used during specific portions of the drilling process. The structure may be part of a product manufactured in the aerospace, marine, or refrigeration industries as typified by, for example, a skin portion attached to a frame substructure. Drill templates are generally useful in such situations for drilling holes in precise locations through the skin and into or through a portion of the frame, for example, for attaching the skin to the frame with fasteners received by the holes. The skin or structure may have a precisely defined exterior surface, referred to as an outer mold surface, mold line surface, or outer mold line (OML).

A drill template includes a contact surface such that a substantially exact fit is achieved between the mold line surface and the contact surface of the drill template. For example, the drill template may be built directly from computer aided design (CAD) engineering solid models using an additive manufacturing process, for example, selective laser sintering (SLS). Although SLS is used as an example throughout to illustrate a type of fabrication process that is compatible with CAD techniques for fabricating a drill template, other types of additive manufacturing processes could be utilized as well. For example, fused deposition modeling (FDM) and stereo-lithography (SLA) fabrication processes also could be used. These and other processes vary only by the method that they fabricate the parts and the materials that they use. More importantly, all the named processes are of the type that include the generation of parts directly from a CAD model.

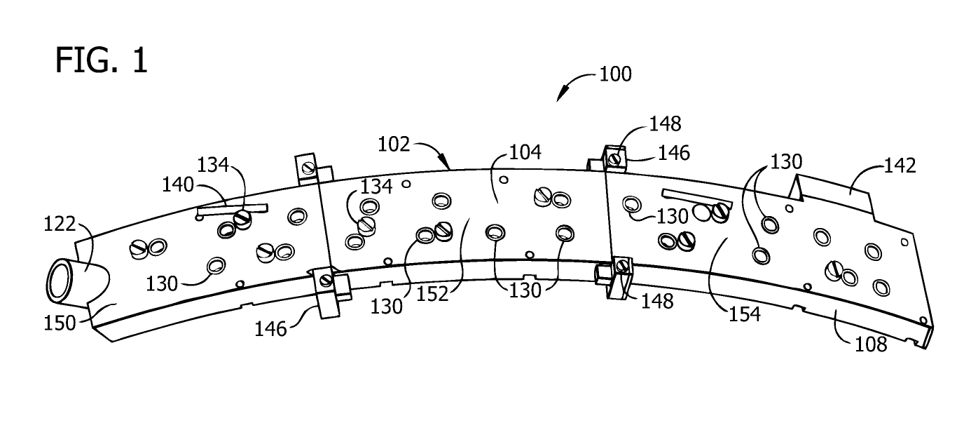

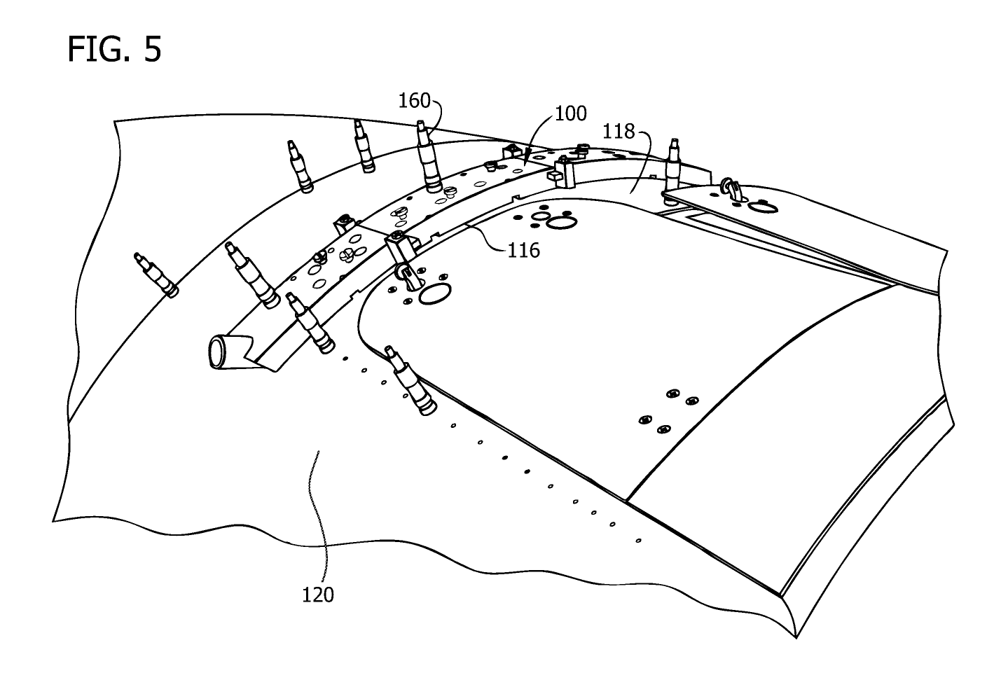

Referring now to FIGS. 1 through 3, in which like items are referenced with the same numeral throughout, a drill template 100 is illustrated in accordance with one embodiment. Drill template 100 may include a vacuum housing 102 having a top surface 104 and an interior surface 106. Vacuum housing 102 may include side skirts 108 and 110, and end skirts 112 and 114. Each of skirts 108, 110, 112, and 114 may have a contact surface 116. For example, skirt 108 may have contact surface 109, skirt 110 may have contact surface 111, skirt 112 may have contact surface 113, and skirt 114 may have contact surface 115, so that contact surfaces 109, 111, 113, and 115 collectively form contact surface 116 of housing 102. Contact surface 116 may be formed using CAD techniques to conform to the CAD engineering solid model of the outside mold line surface of a structure, such as outside mold line surface 118 of structure 120 shown in FIG. 5, which, for example, may be part of an aircraft fuselage.

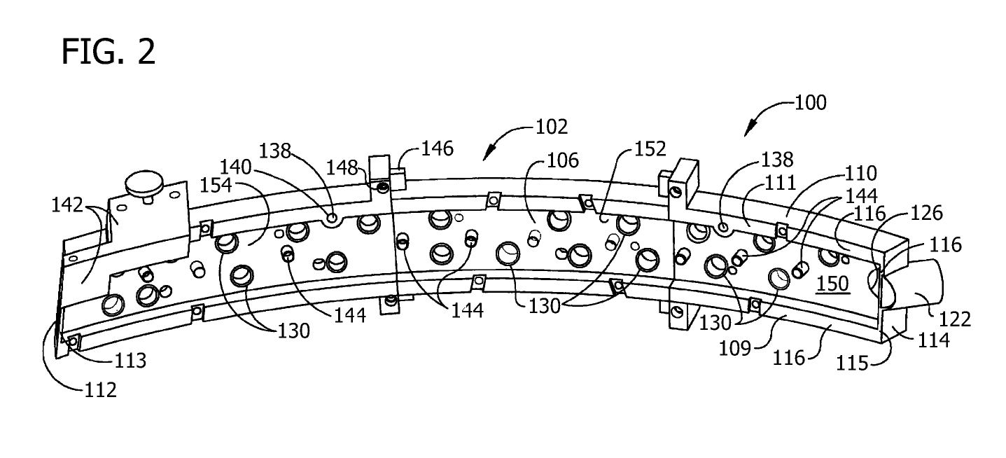

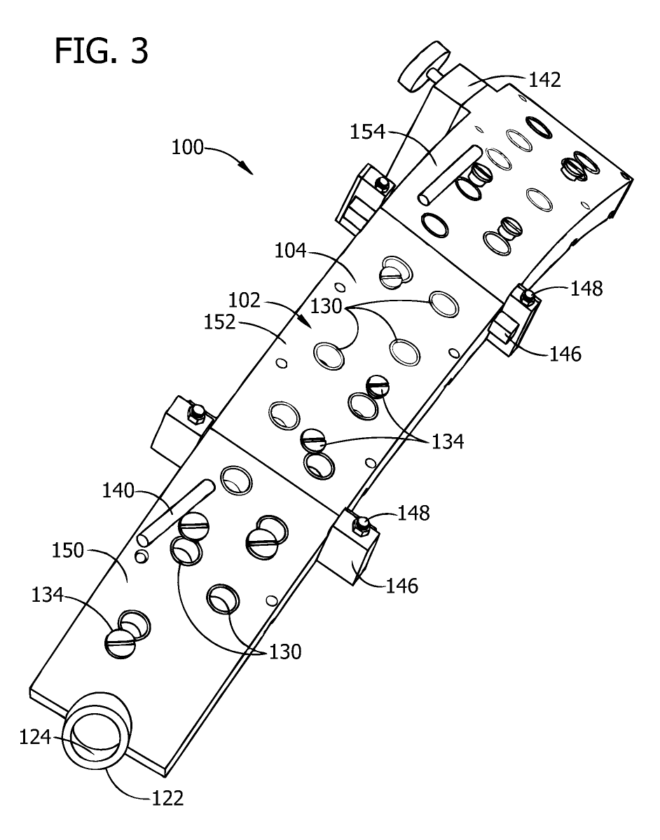

Vacuum housing 102 includes an integral vacuum attach, or vacuum port 122. Vacuum port 122 may include an external, round opening 124, seen in FIG. 3, that may communicate through skirt 114 to an opening 126, seen in FIG. 2, at the interior surface 106 of vacuum housing 102 to provide vacuum from an external vacuum system through opening 124 to opening 126. Vacuum port 122 may be attached to a vacuum hose of a vacuum system so that vacuum may be applied through the hose to the interior vacuum chamber, described above, between structure 120 (shown in FIG. 5) and drill template 100, for removing and collecting drilling debris concurrently with the drilling operation.

Vacuum housing 102 includes drill bushings 130, which may be formed to pass through vacuum housing 102 from top surface 104 to interior surface 106. Drill bushings 130 may be formed so that a drill bit may be inserted into drill bushing 130 and guided by drill bushing 130 to form a precisely placed hole in structure 120.

Vacuum housing 102 may also include one or more drill support attachments 134. A drill support attachment 134 may be positioned near a drill bushing 130. A drill support attachment 134 may be locked onto a drill to help control the placement of a drill bit within one or more of drill bushings 130.

Vacuum housing 102 may include index holes 138 which may extend from top surface 104 to contact surface 116, as shown in FIG. 2. Index holes 138 may be formed to receive an alignment pin 140, as shown in FIGS. 1, 2, and 3. Alignment pins 140 may be temporarily inserted into an index hole drilled in structure 120, including a skin portion of structure 120 or a substructure portion of structure 120. Alignment pins 140 may inserted into index holes 138 to help position and align template 100 so that the holes located by drill bushings 130 may be formed in the desired positions.

Vacuum housing 102 also may include one or more edge of part locators 142. Edge of part locator 142 may be formed, for example, as shown in FIGS. 1 through 3, so that it may fit against an edge of structure 120 at a precise location so that drill template 100 may be located precisely at a pre-defined location relative to structure 120, further helping to position and align template 100 so that the holes located by drill bushings 130 may be formed in the desired positions. Edge of part locator 142 may be formed using CAD techniques to form edge of part locator 142 using the CAD engineering solid model of structure 120 so that edge of part locator 142, and thus vacuum housing 102, fits to a precise location relative to structure 120. Vacuum housing 102 may be fabricated, for example, from nylon using a selective laser sintering process in conjunction with CAD techniques to achieve an exact fit, i.e., being formed using the same CAD solid model as is used to form structure 120, of edge of part locator 142 with the structure 120. The exact fit of edge of part locator 142 to a precise location of structure 120 may enhance the positioning and drilling accuracy of drill template 100.

Vacuum housing 102 may include standoff buttons 144. Standoff buttons 144 may be formed on interior surface 106 of vacuum housing 102, as shown in FIG. 2. Standoff buttons 144 may be used to hold structure 120 steadily in place when a hole is drilled in structure 120 guided by one of the drill bushings 130. For example, an aircraft skin included in structure 120 may be flexible and may bend when a hole is drilled into it. A standoff button 144, however, may hold the aircraft skin so that when the hole is drilled in the skin, the skin may not push back against the drill and change the shape of the drilled hole. Generally, holes drilled in aircraft structures are required to meet tight tolerances in shape and dimension and it may be undesirable to have the hole move during the drilling process.

As shown in FIGS. 1 through 3, vacuum housing 102 of template 100 may be formed from three sections 150, 152, and 154. Sections 150,152, and 154 may be attached together to form drill template 100 so that vacuum housing 102 may have dimensions, for example, within a range of 30 inches to 45 inches. Sections 150 and 152, or sections 152 and 154, may be held together via fastener arms 146, which may be molded as an integral part of the structure of sections 150,152, and 154. Fasteners 148, which may be nut and bolt fasteners, for example, may be inserted in fastener arms 146 and used to hold sections 150 and 152, and sections 152 and 154, together.

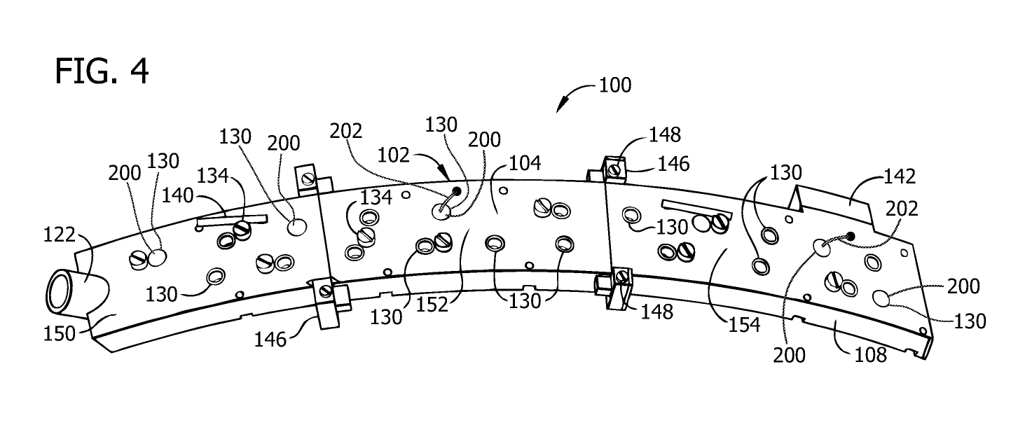

FIG. 4 is an illustration of one embodiment of vacuum housing 102 that is fabricated to include one or more plugs 200 that are insertable, for example, into drill bushings 130. Plugs 200 may be fabricated, for example, from nylon using a selective laser sintering process in conjunction with CAD techniques to achieve an interference fit in the drill bushings 130. For example, plugs 200 may be formed using the same CAD solid model as is used to form structure drill template 100 and vacuum housing 102, and further may be concurrently fabricated with vacuum housing 102. Alternatively, plugs 200 may be fabricated independently from the fabrication of the drill template 100 and vacuum housing 102.

The insertion fit of plugs 200 into one or more of drill bushings 130 of the vacuum housing 102 improves the suction of the vacuum generated at the unplugged drill bushings 130. Moreover, the fit of the plugs 200 into the vacuum housing 102, and the resultant increase in suction may eliminate or decrease any debris or water escaping these unused drill bushings 130. The plugs 200 may be attached to the vacuum housing 102 via a coupling device 202 such as a string, a small cable, or a small chain. Alternatively, the plugs 200 may be inserted into the drill bushings 130 with no attachment to the vacuum housing.

FIG. 5 is an illustration of one embodiment of drill template 100 placed on a structure 120, the drill template 100 having a contact surface 116. Contact surface 116 may be formed using CAD techniques to conform to the CAD engineering solid model of the outside mold line surface of a structure, such as outside mold line surface 118 of structure 120, which, for example, may be part of an aircraft fuselage. Drill template 100 may be secured to structure 120, for example, using pin clamps 160, inserted, for example, in index holes formed in drill template 100 and structure 120.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of reducing foreign object debris (FOD) during drilling comprising:
disposing a vacuum housing with a computer aided design (CAD) formed drill template in an operative position on a work piece;
actuating a vacuum operatively connected to the vacuum housing, thereby creating negative pressure between the template and the work piece, the negative pressure acting on the debris resulting from the drilling operations; and
enhancing the negative pressure without manipulating the vacuum.

2. The method according to claim 1 wherein the enhancing the negative pressure further comprises plugging drill bushings formed in the template when such drill bushings are not being used for guiding a drill during a drilling operation.

3. The method according to claim 2 wherein plugging the unused drill bushings further comprises fabricating plugs utilizing an additive manufacturing process.

4. The method according to claim 3 wherein fabricating plugs utilizing an additive manufacturing process comprises using selective laser sintering to fabricate the plugs.

5. The method according to claim 2 wherein fabricating plugs utilizing an additive manufacturing process comprises concurrently fabricating the drill template and the plugs utilizing the additive manufacturing process.

6. A drill template for placement adjacent a structure, said drill template comprising:
a vacuum housing comprising a structure contact surface defined to fit adjacent a mold line surface of the structure;
a vacuum port extending from said vacuum housing;
a plurality of drill bushings extending through said vacuum housing from an outer surface to an inner surface of said vacuum housing, said drill bushings in fluid communication with said vacuum port; and
at least one drill bushing plug operable for insertion into one of said drill bushings, and further operable for preventing ingress or egress of fluid or debris through said drill bushing into which said drill bushing plug is inserted and further operable for increasing a draw through another of said drill bushings when a vacuum is attached to said vacuum port, said vacuum housing, said vacuum port, said drill bushings, and said at least one drill bushing plug concurrently fabricated using an additive manufacturing process.

7. The drill template according to claim 6 wherein s said vacuum housing, said vacuum port, said drill bushings, and said at least one drill bushing plug are defined using computer aided design (CAD).

8. The drill template according to claim 7 wherein said at least one drill bushing plug is fabricated from the same CAD solid model used to form said vacuum housing, said vacuum port, and said drill bushings.

9. The drill template according to claim 6 wherein said at least one drill bushing plug is removable from an associated said drill bushing.

10. The drill template according to claim 6 wherein said said vacuum port, said vacuum housing, said vacuum port, said drill bushings, and said at least one drill bushing plug are fabricated using at least one of selective laser sintering, fused deposition modeling, or stereo-lithography.
